(19) United States
(12) Patent Application Publication
(10) Pub. No.: US 2025/0274413 A1
(43) Pub. Date: Aug. 28, 2025

(54) WORK SUPPORT SYSTEM, WORK SUPPORT METHOD, AND INFORMATION STORAGE MEDIUM

(71) Applicants: Cybozu, Inc., Tokyo (JP); Cybozu Labs, Inc., Tokyo (JP)

(72) Inventors: Hiroaki IKUTA, San Francisco, CA (US); Kaoru NAKAJIMA, Tokyo (JP); Kota UCHIDA, Fujimino-shi (JP); Hideki IGARASHI, Yokohama-shi (JP); Hayato SHIMOJI, Ichinomiya-shi (JP)

(21) Appl. No.: 19/059,268

(22) Filed: Feb. 21, 2025

(30) Foreign Application Priority Data
Feb. 26, 2024 (JP) 2024-026514

(51) Int. Cl. H04L 51/046; H04L 51/224; H04L 51/48

(52) U.S. Cl. CPC H04L 51/046; H04L 51/224; H04L 51/48

(57) ABSTRACT

Provided is a work support system including at least one processor configured to: acquire posted data relating to a post in the work support system; determine, based on the posted data, whether a mention designating an addressee and reaction information relating to a reaction the addressee is requested to perform has been made; and request the addressee to perform the reaction when it is determined that the mention has been made.

### CROSS-REFERENCE TO RELATED APPLICATION

The present disclosure contains subject matter related to that disclosed in Japanese Patent Application JP 2024-026514 filed in the Japan Patent Office on Feb. 26, 2024, the entire contents of which are hereby incorporated by reference.

### BACKGROUND OF THE INVENTION

### 1. Field of the Invention

The present disclosure relates to a work support system, a work support method, and an information storage medium.

### 2. Description of the Related Art

Hitherto, there has been known a “mention function” in which a user designates a specific party and makes a post. For example, in Japanese Patent Application Laid-open No. 2023-047417, there is described a chat service in which, in a chat having a mention function, when a user designates another user who is to be mentioned and posts a message, the chat service notifies the another user. The user can also use such a chat service to contact the another user about a business matter.

However, in the technology of Japanese Patent Application Laid-open No. 2023-047417, even when the user who has been mentioned is requested to perform some sort of reaction, it is impossible for the mentioned user to know what reaction he or she has been requested to perform unless the mentioned user reads the body text of the post. For this reason, the technology of Japanese Patent Application Laid-open No. 2023-047417 requires a lot of effort from the user. Further, in the technology of Japanese Patent Application Laid-open No. 2023-047417, the user may overlook the reaction he or she has been requested to perform. Thus, the technology of Japanese Patent Application Laid-open No. 2023-047417 does not sufficiently increase convenience of the user.

### SUMMARY OF THE INVENTION

One object of the present disclosure is to increase convenience of a user.

According to at least one aspect of the present disclosure, there is provided a work support system including at least one processor configured to: acquire posted data relating to a post in the work support system; determine, based on the posted data, whether a mention designating an addressee and reaction information relating to a reaction the addressee is requested to perform has been made; and request the addressee to perform the reaction when it is determined that the mention has been made.

### BRIEF DESCRIPTION OF THE DRAWINGS

FIG. 1 is a diagram for illustrating an example of a hardware configuration of a work support system.

FIG. 2 is a view for illustrating an example of screens displayed on a user terminal.

FIG. 3 is a view for illustrating an example of screens displayed on the user terminal.

FIG. 4 is a view for illustrating an example of screens displayed on the user terminal.

FIG. 5 is a diagram for illustrating an example of functions implemented in the work support system.

FIG. 6 is a table for showing an example of a user database.

FIG. 7 is a table for showing an example of a post database.

FIG. 8 is a table for showing an example of a notification database.

FIG. 9 is a flowchart for illustrating an example of post processing.

FIG. 10 is a flowchart for illustrating an example of notification processing.

FIG. 11 is a diagram for illustrating an example of functions implemented in a work support system according to modification examples.

FIG. 12 is a view for illustrating an example of a thread screen in Modification Example 4.

FIG. 13 is a view for illustrating an example of the thread screen in Modification Example 6.

FIG. 14 is a view for illustrating an example of notification screens in Modification Example 8.

### DESCRIPTION OF THE EMBODIMENTS

### [1. Hardware Configuration]

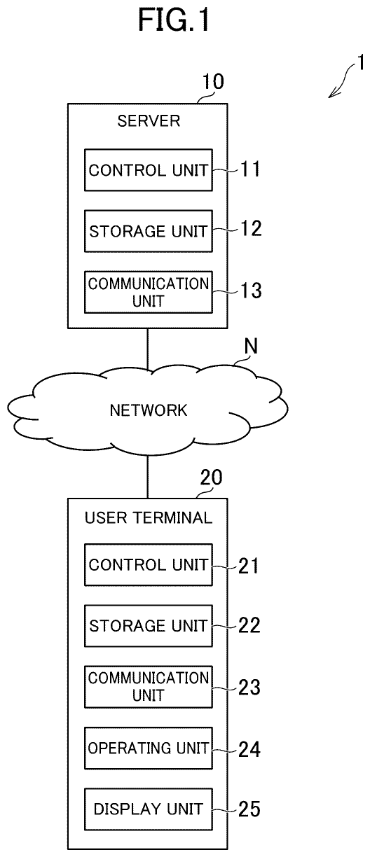

An example of a work support system, a work support method, and a program according to at least one embodiment of the present disclosure is described. FIG. 1 is a diagram for illustrating an example of a hardware configuration of the work support system. For example, a work support system 1 includes a server 10 and a user terminal 20. The server 10 and the user terminal 20 are each connected to a network N such as the Internet or a LAN. In FIG. 1, one server 10 and one user terminal 20 are illustrated, but a plurality of servers 10 may be present, and a plurality of user terminals 20 may be present.

The server 10 is a server computer. For example, the server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The user terminal 20 is a computer of a user. For example, the user terminal 20 is a personal computer, a tablet terminal, a smartphone, or a wearable terminal. For example, the user terminal 20 includes a control unit 21, a storage unit 22, a communication unit 23, an operating unit 24, and a display unit 25. Hardware configurations of the control unit 21, the storage unit 22, and the communication unit 23 may be the same as those of the control unit 11, the storage unit 12, and the communication unit 13, respectively. The operating unit 24 is an input device such as a mouse or a touch panel. The display unit 25 is a liquid crystal display or an organic EL display.

Programs stored in the storage units 12 and 22 may be supplied via the network N. A hardware configuration of each of the server 10 and the user terminal 20 is not limited to the example of FIG. 1. For example, at least one of the server 10 or the user terminal 20 may include at least one of a reading unit (for example, a memory card slot) that reads a computer-readable information storage medium or an input/output unit (for example, a USB terminal) for directly connecting to an external device. A program stored in the information storage medium may be supplied to at least one of the server 10 or the user terminal 20 through at least one of the reading unit or the input/output unit.

Moreover, the work support system 1 is only required to include at least one computer. The computers included in the work support system 1 are not limited to the example of FIG. 1. For example, the work support system 1 may include only the server 10. In this case, the user terminal 20 is present outside the work support system 1. The work support system 1 may include the server 10 and another server computer.

### [2. Overview of Work Support System]

In the at least one embodiment, the work support system 1 has various functions that support work of users. For example, the work support system 1 may provide users with groupware of a cloud type or an on-premises type. The work support system 1 may provide users with a service that is not classified as groupware but supports work. For example, the user terminal 20 communicates to and from the server 10 and displays various screens in the work support system 1 on the display unit 25.

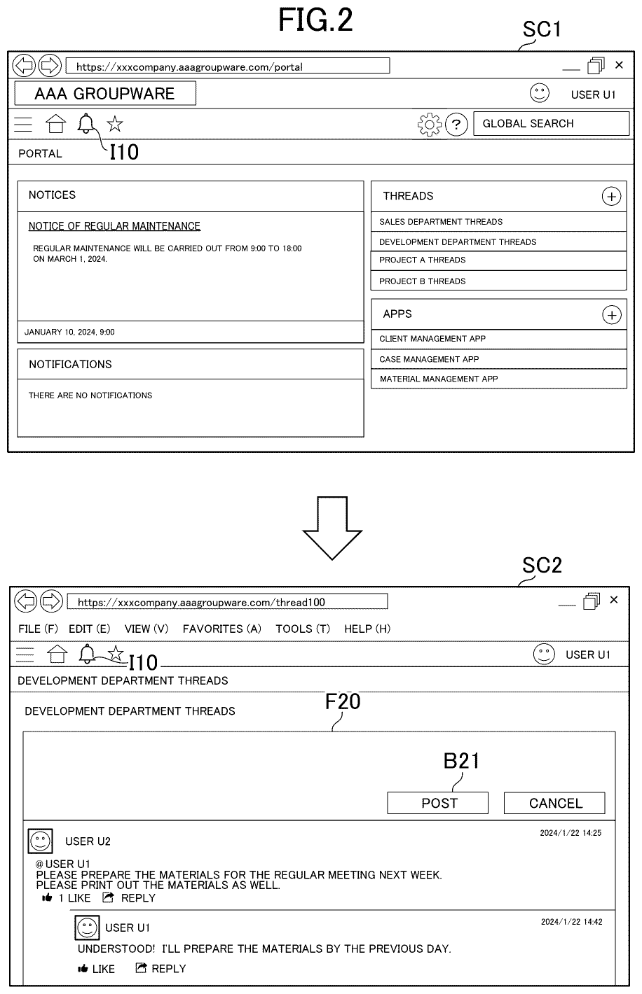

FIG. 2 to FIG. 4 are views for illustrating examples of screens displayed on the user terminal 20. For example, when a user logs in to the work support system 1, as in the upper half of FIG. 2, the user terminal 20 displays, on the display unit 25, a portal screen SC1 corresponding to the entrance to the work support system 1. The user can use the various functions that the work support system 1 has from the portal screen SC1. For example, from the portal screen SC1, the user may select a given thread and communicate with another user, or may register data relating to the work of the user in an application, which is a type of database.

In the at least one embodiment, among the functions that the work support system 1 has, a mention function is mainly described. The mention function is a function that allows a user who has made a post in the work support system 1 to mention a specific party. A post is the content of communication between users. A post can also be referred to as a “message” or a “comment.” Posts may be made at any place in the work support system 1. For example, posts may be made in a thread, a bulletin board not categorized as a thread, an app, a shared email, a schedule, a chat, or some other place.

The term “mention” refers to the designation of a specific party as an addressee by the user. The user can mention any party. A user who has been mentioned is notified that a post has been made. For example, when a certain user is mentioned, the server 10 uses the notification function of the work support system 1 to notify the user. The notification may be issued in any manner. For example, the server 10 may notify the user by email, a short message service (SMS), a push notification, a banner notification, a badge notification, a messaging app, a social networking service (SNS), or another method. A combination of those plurality of notification methods may be used.

In the at least one embodiment, a case in which a post is made to a thread, which is a type of bulletin board, is taken as an example. For example, when the user selects any thread from the portal screen SC1, as in the lower half of FIG. 2, the user terminal 20 displays, on the display unit 25, a thread screen SC2 indicating the thread selected by the user. The thread screen SC2 displays the content of the post made to the thread. The user can input a new post into an input form F20. A case in which a user U1 mentions a user U2 in the post is described below.

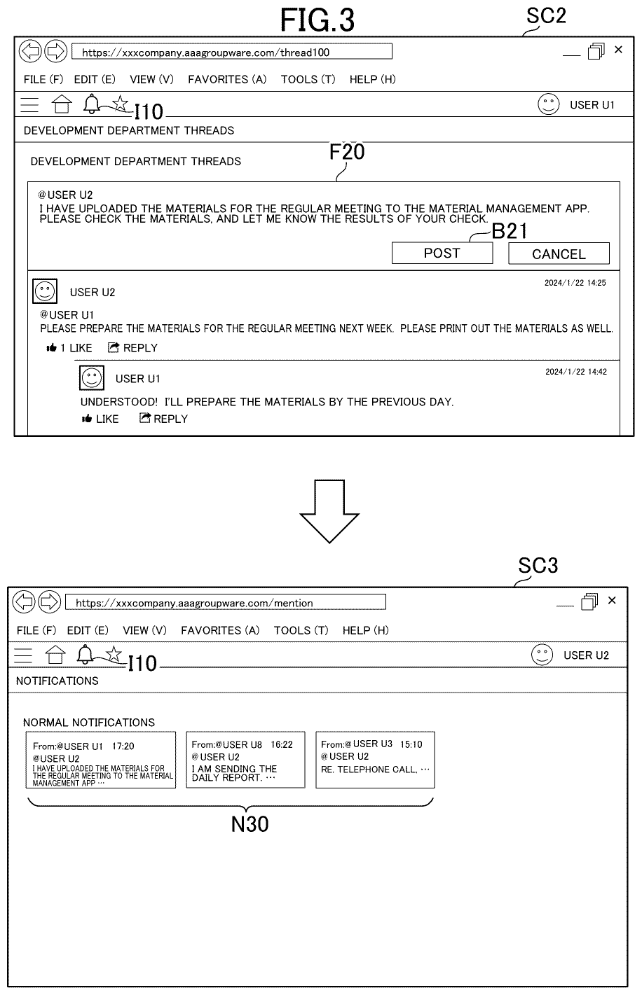

For example, as in the upper half of FIG. 3, the user U1 inputs a post including the character string “@userU2,” which means that the mention designates the user U2 as the addressee, into the input form F20. In the at least one embodiment, a case in which mentions are made by using the symbol “@” is taken as an example, but mentions may be made by using other symbols. Mentions may be made by using any method, and may be made by selecting an image such as a button instead of inputting a symbol.

For example, when the user U1 selects a button B21, the input of the post is complete. The server 10 can determine that the user U1 has mentioned the user U2 based on a portion of the character string “@userU2” in the post made by the user U1. When the server 10 determines that the user U2 has been mentioned, the server 10 notifies the user U2 that the user U2 has been mentioned. When the user U2 selects an icon I10 on the portal screen SC1 of the user U2, as in the lower half of FIG. 3, the user terminal 20 of the user U2 displays, on the display unit 25 of the user terminal 20, a notification screen SC3 showing the notifications received by the user U2.

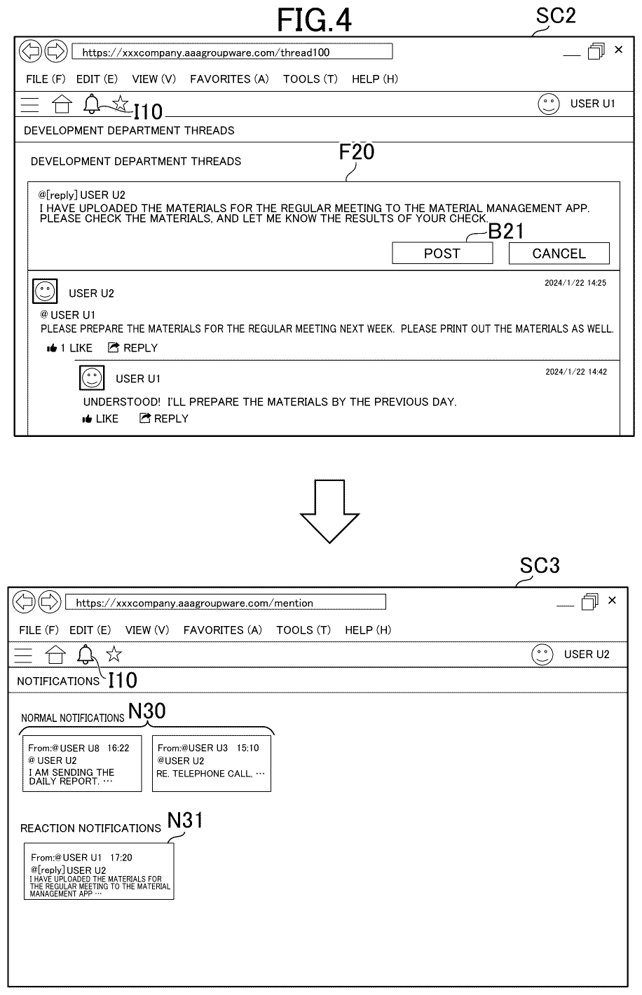

In the at least one embodiment, the user U1 can designate not only the addressee of the mention but also reaction information relating to a reaction the addressee is requested to perform. The reaction information is a portion of a post that indicates the reaction. For example, when the user U1 requests a reply from the user U2 as a reaction, as in the upper half of FIG. 4, the user U1 inputs a post including the character string “@[reply]userU2,” which means that the mention designates the user U2 as the addressee and requests a reply to the post as a reaction. The character string “@[reply]userU2” may be input at any position in the post. The character string “@[reply]userU2” may be input in a portion other than the beginning of the post like in the upper half of FIG. 4.

For example, in the character string “@[reply]userU2,” the square brackets are a designation of the reaction information. The character string “reply” in the square brackets indicates the content of the reaction. When a reaction other than a reply is requested, the portion in the square brackets is another character string. For example, when checking of the post is requested as the other reaction, the portion in the square brackets may be the character string “check?”. In the character string “@[reply]userU2,” the character string “userU2” after the portion indicating the reaction indicates the addressee of the mention.

For example, the server 10 determines, based on the portion of the character string “@[reply]userU2” in the post by the user U1, that a mention in which the user U2 is designated as the addressee and a reply is requested as the reaction by the user U2 has been made. This determination may be performed by the user terminal 20. The server 10 notifies the user U2 that the user U2 has been designated as the addressee and that a reply is requested as the reaction. A notification in the case which reaction information is designated is hereinafter referred to as “reaction notification N31,” and a notification in the case which reaction information is not designated is hereinafter referred to as “normal notification N30.” The notification that is displayed on the notification screen SC3 in the lower half of FIG. 3 is a normal notification N30.

As in the lower half of FIG. 4, the reaction notification N31 received by the user U2 is displayed on the notification screen SC3 of the user U2. In the example of the lower half of FIG. 4, the normal notifications N30 and the reaction notification N31 are distinguished from each other on the notification screen SC3. For example, the normal notifications N30 are displayed in a first display area allocated to the normal notifications N30 on the notification screen SC3. On the notification screen SC3, the reaction notification N31 is displayed in a second display area allocated to the reaction notifications N31. When the user U2 selects the reaction notification N31, the user terminal 20 of the user U2 displays the thread screen SC2 showing the details of the post indicated by the reaction notification N31.

As described above, the user U1 can not only designate the user U2 as the addressee, but can also request that the user U2 perform a reaction. Through checking the reaction notification N31 displayed on the notification screen SC3, the user U2 can easily grasp not only that the user U2 has been designated as the addressee, but also that the user U2 has been requested to perform a reaction. The work support system 1 can increase convenience of the users U1 and U2 based on such a mention mechanism. Details of the work support system 1 are described below.

### [3. Functions Implemented in Work Support System]

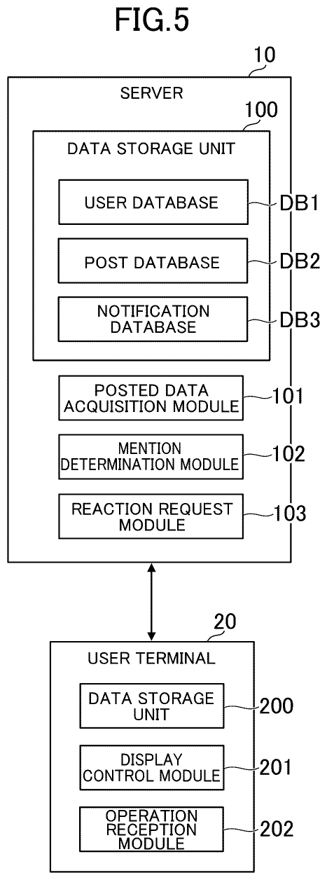

FIG. 5 is a diagram for illustrating an example of functions implemented in the work support system 1. In the at least one embodiment, among the functions of the work support system 1, the mention function for a mention designating the reaction information is mainly described.

### [3-1. Functions Implemented in Server]

For example, the server 10 includes a data storage unit 100, a posted data acquisition module 101, a mention determination module 102, and a reaction request module 103. The data storage unit 100 is implemented by the storage unit 12. Each of the posted data acquisition module 101, the mention determination module 102, and the reaction request module 103 is implemented by the control unit 11.

### [Data Storage Unit]

The data storage unit 100 stores data required for supporting work. For example, the data storage unit 100 stores a user database DB1 in which various kinds of data on users are stored, a post database DB2 in which various kinds of data on posts made in the work support system 1 are stored, and a notification database DB3 in which various kinds of data on notifications issued to users are stored.

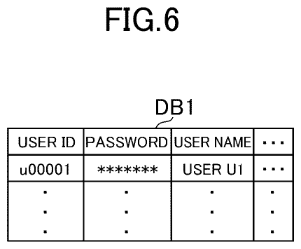

FIG. 6 is a table for showing an example of the user database DB1. For example, the user database DB1 stores data such as a user ID for identifying each user, a password, a user name, and an organization to which the user belongs. The user database DB1 may store any data relating to the user. For example, the user database DB1 may store data indicating a work position, department, year of employment, years of service, or other information of a user. In the at least one embodiment, a case in which a user name is used for the designation of the addressee of the mention is taken as an example, but other information such as a user ID may also be used for the designation of the addressee of the mention.

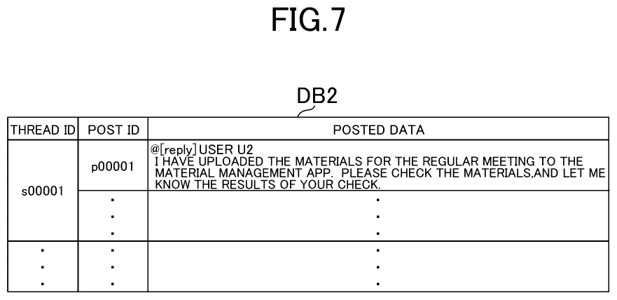

FIG. 7 is a table for showing an example of the post database DB2. In the at least one embodiment, a post to a thread is taken as an example, and hence the post database DB2 stores a thread ID, which is an ID for identifying a thread, a post ID, which is an ID for identifying a post, and posted data indicating a post to the thread. Any data may be stored in the post database DB2. The data stored in the post database DB2 is not limited to the example of FIG. 7. For example, the post database DB2 may store the user ID of the user who has made the post, the date and time of the post, the addressee designated by the mention, the content of the reaction requested by the mention, and the like.

For example, when the user creates a new thread, the server 10 issues a thread ID for the thread. When a new post is made to the thread, the posted data acquisition module 101 described later issues a post ID for the post. The posted data acquisition module 101 stores, in the post database DB2, the posted data indicating the new post in association with the thread ID and the post ID. The posted data may include not only text indicating content of the post, but also other data such as a file included in the post. The post database DB2 may store data on a notification issued as a result of the post.

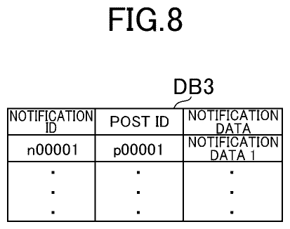

FIG. 8 is a table for showing an example of the notification database DB3. For example, the notification database DB3 stores a notification ID for identifying a notification, a post ID of the post which caused the notification, and notification data relating to the specific content of the notification and the like. For example, when a new post in which a mention has been made is made, the server 10 issues a notification ID for the new notification. The server 10 stores the notification ID, the post ID, and the notification data of the new notification in the notification database DB3 in association with each other.

The notification data indicates information required for a notification. For example, the notification data indicates a notification type, an addressee, and information relating to display of the notification. The notification type indicates whether the notification is a normal notification N30 or a reaction notification N31. The type of the reaction notification N31 may indicate the specific content of the reaction. For example, the type of the reaction notification N31 may indicate the specific content of the reaction, such as replying to a post, checking of a post, or another reaction.

The addressee is the party designated by the user who has made the post. Addressee can also be referred to as “mention destination.” The addressee may be a person or a group. A group is a collection of at least one user. The group may be any unit. When the users of an organization such as a company use the work support system 1, the group may be the organization or a department within the organization. As another example, the group may be a team or a project. The users may be allowed to create any group. When a person is mentioned, the addressee indicates the user ID of the user who is mentioned as a person. When a group is mentioned, the addressee indicates the group ID of the group that is mentioned.

The specific content of the notification may be the character string of all or a part of the post, the user ID or user name of a poster who has made the post, the posting date and time, information on whether the notification is unread or read, or a combination of those. The notification data may include other information required for the notification. The format of the notification data is not limited to the example of the at least one embodiment. The notification data may indicate whether or not the reaction the addressee is requested to perform has been completed. That is, the notification data may indicate a current status of the reaction the addressee is requested to perform. When the server 10 detects that the addressee user has performed the reaction on the work support system 1, the server 10 updates the notification data to indicate that the reaction by the user has been completed.

The data stored in the data storage unit 100 is not limited to the above-mentioned example. The data storage unit 100 may store any data. For example, the data storage unit 100 may store data indicating a specific symbol (for example, “@”) that serves as a criterion for determining whether or not a mention has been made. The data storage unit 100 may store reaction definition data in which a relationship between each of a plurality of reactions and a character string for designating those pieces of reaction information is defined. The reaction definition data may be in any format, for example, a table format, a mathematical expression format, data written in a markup language, a part of a program, a machine learning model, or another format. For example, the data storage unit 100 may store data (for example, HTML data) required for displaying each of the portal screen SC1, the thread screen SC2, and the notification screen SC3.

### [Posted Data Acquisition Module]

The posted data acquisition module 101 acquires the posted data indicating a post made in the work support system 1. For example, the posted data acquisition module 101 acquires the posted data from the user terminal 20. The posted data indicates a character string input by the user. The posted data may indicate information other than a character string. Examples to be indicated by the posted data may include an emoji, a file, an image, a video, a link, and other information that are designated by the user. In the examples of the thread screen SC2 of FIG. 3 and FIG. 4, the posted data indicates a post input by the user into the input form F20. Instead of directly storing the posted data acquired from the user terminal 20 in the post database DB2, the posted data acquisition module 101 may add information to the posted data, or delete or change a part of the information in the posted data, and then store the posted data in the post database DB2.

For example, when the user makes a new post to a certain thread, the user terminal 20 transmits, to the server 10, the thread ID of the thread to which the new post has been made and the posted data indicating the new post. The posted data acquisition module 101 acquires the thread ID and the posted data from the user terminal 20. The posted data acquisition module 101 stores the thread ID and the posted data that have been acquired from the user terminal 20 in the post database DB2 in association with each other. The posted data acquisition module 101 can acquire the posted data stored in the post database DB2 at any timing. The posted data acquisition module 101 may generate the posted data based on the data acquired from the user terminal 20 instead of acquiring the posted data itself from the user terminal 20.

### [Mention Determination Module]

The mention determination module 102 determines, based on the posted data, whether or not a mention designating an addressee and reaction information relating to a reaction the addressee is requested to perform has been made. In the at least one embodiment, it is possible to make mentions in which an addressee is designated but reaction information is not designated, and mentions in which both an addressee and reaction information are designated. The method of determining whether a mention is a mention designating an addressee but not reaction information may be the same as a publicly-known method. The method of determining whether a mention is a mention designating both an addressee and reaction information may be a determination method in which a part of a publicly-known method is used.

In the at least one embodiment, a case in which a mention designating an addressee but not reaction information is made by inputting a character string indicating the addressee (for example, a username) after a specific symbol (for example, “@”) is taken as an example. A mention designating both an addressee and reaction information is made by inputting a character string indicating the reaction between the specific symbol and the character string indicating the addressee. For the mention, a symbol other than “@” may be used, or an image such as a button may be used instead of inputting a symbol.

For example, the mention determination module 102 determines, based on the reaction definition data, whether or not a character string indicating a reaction has been input after a specific symbol in the post indicated by posted data. When the mention determination module 102 determines that a character string indicating a reaction has not been input after a specific symbol, the mention determination module 102 does not determine that a mention designating both an addressee and reaction information has been made. When the mention determination module 102 determines that a character string indicating a reaction has been input after a specific symbol, the mention determination module 102 determines that a mention designating both an addressee and reaction information has been made. Further, the mention determination module 102 identifies which reaction information has been designated among the plurality of reactions based on the reaction definition data.

The series of determinations of the mention in which an addressee and reaction information are designated may be performed by the user terminal 20. In this case, the posted data may indicate the determination result obtained by the user terminal 20. The determination result obtained by the user terminal 20 may be shown in data separate from the posted data. It suffices that the user terminal 20 determines, based on the result of the input performed by the user, whether or not a mention designating an addressee and reaction information has been made. The mention determination module 102 may determine, based on the determination result obtained by the user terminal 20, whether or not a mention designating an addressee and reaction information has been made.

Further, the mention determination module 102 may perform the determination in accordance with the mention method defined by the work support system 1. For example, when a mention is made by selecting a specific image or text displayed on the thread screen SC2, the mention determination module 102 may determine whether or not a mention has been made by determining whether or not the specific image or text has been selected. The mention determination module 102 may determine whether or not a mention has been made by determining whether or not the posted data includes information in a specific format indicating a mention. The information in a specific format may be data separate from the posted data. For example, the mention determination module 102 may determine whether or not the data accompanying the posted data indicates a mention.

### [Reaction Request Module]

The reaction request module 103 requests, when it is determined that a mention designating an addressee and reaction information has been made, the addressee to perform a reaction. The reaction request module 103 requesting the addressee to perform a reaction means that the reaction request module 103 transmits data indicating that the reaction is requested to the user terminal 20 of the user who is the addressee, or that data required for transmission of such data is recorded in the data storage unit 100. For example, the reaction request module 103 requesting the addressee to perform a reaction means that the reaction request module 103 associates addressee identification information that can identify the addressee with reaction identification information that can identify the reaction. The addressee identification information is the user ID or the group ID. The reaction identification information may indicate whether or not a reaction is requested or may indicate the specific content of the reaction. The reaction identification information can also be referred to as “meta information for the addressee.”

For example, the reaction request module 103 requests the addressee to perform the reaction by storing the addressee identification information and the reaction identification information in the notification database DB3 in association with each other. In the at least one embodiment, a case in which the addressee identification information and the reaction identification information are associated in the notification data is taken as an example. When a person is designated as the addressee, the reaction request module 103 stores the user ID of the user designated as a person and the reaction identification information in the notification database DB3 in association with each other. When a group is designated as the addressee, the reaction request module 103 stores the user ID of at least one user belonging to the group and the reaction identification information in the notification database DB3 in association with each other.

The method by which the reaction request module 103 requests the addressee to perform the reaction is not limited to the example described above. For example, the reaction request module 103 may store the addressee identification information and the reaction identification information in another database, such as the post database DB2, in association with each other. When the reaction request module 103 receives a request to display the notification screen SC3 from the user terminal 20 of the mentioned user, the reaction request module 103 may acquire the notification data of the notification in which the user ID of the user is designated as the addressee from the notification database DB3, and based on the notification data, request the user to perform the reaction by displaying the notification screen SC3 on the user terminal 20.

As another example, the reaction request module 103 may request the addressee to perform the reaction by transmitting, to the addressee, reaction request data indicating a request for the reaction. When a person is designated as the addressee, the reaction request module 103 may transmit, as the reaction request data, an email indicating that a reaction is requested to the email address of the user who has been designated as a person. When a group is designated as the addressee, the reaction request module 103 may transmit, as the reaction request data, an email indicating that a reaction is requested to a group email address of the whole group or to the email address of at least one user belonging to the group.

In the at least one embodiment, the reaction request module 103 issues a reaction notification N31 that is distinguished from the normal notifications N30. A reaction notification N31 distinguished from the normal notifications N30 is a reaction notification N31 that the user can recognize as a notification which is different from the normal notifications N30. For example, a reaction notification N31 which is displayed in a display area or on a screen different from the display area or the screen where the normal notifications N30 are displayed corresponds to a reaction notification N31 distinguished from the normal notifications N30. A reaction notification N31 that is filtered and displayed separately from the normal notifications N30 corresponds to a reaction notification N31 distinguished from the normal notifications N30.

For example, the reaction request module 103 may issue a reaction notification N31 distinguished from the normal notifications N30 by displaying the reaction notification N31 on a notification screen SC3 (second notification screen) which is different from the notification screen SC3 (first notification screen) on which the normal notifications N30 are displayed. The reaction request module 103 generating data for displaying the reaction notification N31 may correspond to the reaction request module 103 issuing the reaction notification N31. When other means such as email are to be used instead of displaying on the notification screen SC3, the reaction request module 103 uses the other means to issue the reaction notification N31 so that the reaction notification N31 is distinguished from the normal notifications N30. In the case of email, the subject or the body text indicates that the notification is a reaction notification N31.

The method by which the reaction request module 103 distinguishes between the normal notifications N30 and the reaction notifications N31 is not limited to the above-mentioned example. For example, the reaction request module 103 may distinguish between the normal notifications N30 and the reaction notifications N31 by notifying the normal notifications N30 in a first notification mode and notifying the reaction notifications N31 in a second notification mode. The notification mode is the way in which the notification is issued. The notification mode can also be referred to as “notification method.” For example, the notification mode may be the color, size, shape, display position, character string, or a combination thereof, of the notification. The second notification mode is a notification mode different from the first notification mode. When color is used for the notification mode, the reaction request module 103 distinguishes between the normal notifications N30 and the reaction notifications N31 by issuing the normal notifications N30 in a first color and issuing the reaction notifications N31 in a second color. When another notification mode other than color is used for the notification mode, the reaction request module 103 may distinguish between the normal notifications N30 and the reaction notifications N31 by using the another notification mode.

Further, the reaction request module 103 issuing a reaction notification N31 may mean that the reaction request module 103 generates the display data of the notification screen SC3, or that the reaction request module 103 generates the data required for displaying the reaction notification N31 and stores the generated data in the notification database DB3. In the at least one embodiment, a case in which both of those operations correspond to the reaction request module 103 issuing the reaction notification N31 is taken as an example, but the reaction request module 103 performing any one of those operations may correspond to the reaction request module 103 issuing the reaction notification N31. This point also applies to cases in which the reaction notification N31 is issued by using another method other than the notification screen SC3.

For example, the reaction request module 103 issues the notification ID of the reaction notification N31 when it is determined that a mention designating an addressee and reaction information has been made. The reaction request module 103 stores the post ID of the post in which the mention designating an addressee and reaction information has been made, the notification ID of the notification, and the notification data of the reaction notification N31 in the notification database DB3 in association with one another. When a certain user logs in to the work support system 1, the reaction request module 103 issues a reaction notification N31 to the user based on those above-mentioned pieces of data associated with the user ID of the user.

In the at least one embodiment, the reaction request module 103 displays, on the user terminal 20, a notification screen SC3 showing a reaction notification N31 that includes at least a part of a post designating an addressee and reaction information. When a certain user instructs that the notification screen SC3 be displayed, the reaction request module 103 displays, on the user terminal 20 of the user, the notification screen SC3 showing the reaction notification N31 for the user based on the notification database DB3.

### [3-2. Functions Implemented in User Terminal]

For example, the user terminal 20 includes a data storage unit 200, a display control module 201, and an operation reception module 202. The data storage unit 200 is implemented by the storage unit 22. Each of the display control module 201 and the operation reception module 202 is implemented by the control unit 21.

### [Data Storage Unit]

The data storage unit 200 stores data for the work support. For example, the data storage unit 200 stores a browser for displaying various screens of the work support system 1. For example, the data storage unit 200 stores an application dedicated to the work support system 1.

### [Display Control Module]

The display control module 201 displays various screens in the work support system 1 on the display unit 25. For example, the display control module 201 displays, on the display unit 25, each of the portal screen SC1, the thread screen SC2, and the notification screen SC3 based on data received from the server 10.

### [Operation Reception Module]

The operation reception module 202 receives various operations in the work support system 1. For example, the operation reception module 202 receives operations performed on each of the portal screen SC1, the thread screen SC2, and the notification screen SC3. Data indicating the operation content received by the operation reception module 202 is transmitted to the server 10 as appropriate.

### [4. Processing Executed in Work Support System]

An example of processing executed in the work support system 1 is described. In the at least one embodiment, post processing executed when the user makes a post and notification processing executed when the user requests display of a notification are described. The post processing and the notification processing are each executed by the control units 11 and 21 executing the programs stored in the storage units 12 and 22, respectively.

### [4-1. Post Processing]

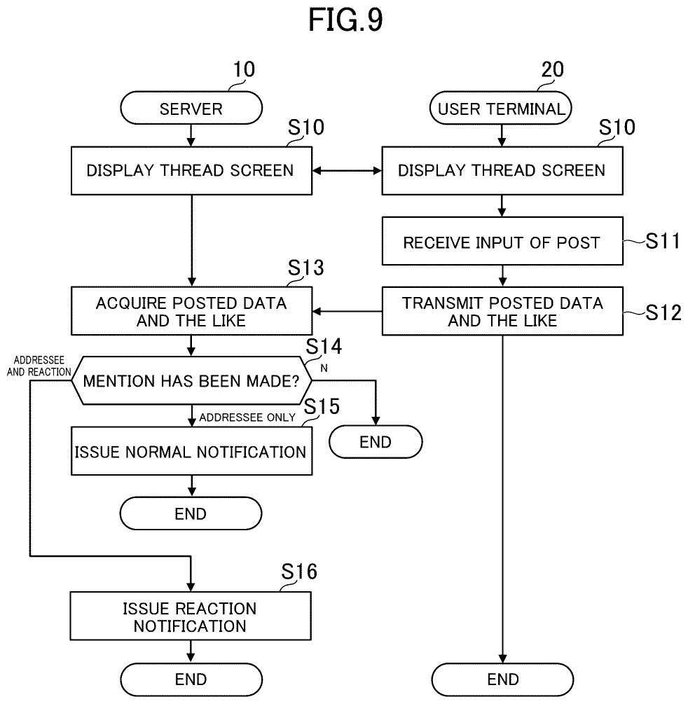

FIG. 9 is a flowchart for illustrating an example of the post processing. In the at least one embodiment, a case in which the user posts to a thread is taken as an example, and hence when the user selects a freely-selected thread, the post processing is executed. The server 10 executes, between the server 10 and the user terminal 20, processing for displaying the thread screen SC2 indicating the thread selected by the user based on the post database DB2 (Step S10). In Step S10, the server 10 generates display data (for example, HTML data) on the thread screen SC2 based on the posted data of existing posts in the thread, and transmits the generated display data to the user terminal 20. The user terminal 20 displays the thread screen SC2 as illustrated in the lower half of FIG. 2 on the display unit 25 based on the display data.

The user terminal 20 receives input of a post into the input form F20 (Step S11). In Step S11, the user can make a post including the character string for designating the addressee and the reaction information, or can make a post that does not particularly include such a character string. When the user selects the button B21, the user terminal 20 transmits, to the server 10, the thread ID of the thread being displayed and the posted data indicating the post input by the user (Step S12). The server 10 acquires the thread ID and the posted data from the user terminal 20 (Step S13). In Step S13, the server 10 issues a post ID, and stores the thread ID, the post ID, and the posted data in the post database DB2 in association with one another.

The server 10 determines whether or not a mention has been made based on the user database DB1 and the posted data (Step S14). In Step S14, the server 10 determines whether or not any one of a mention designating only an addressee and a mention designating an addressee and reaction information has been made. When it is determined in Step S14 that neither of those mentions has been made (N in Step S14), the post processing ends. In this case, a notification is not issued.

When it is determined in Step S14 that a mention designating only an addressee has been made (“Addressee Only” in Step S14), the server 10 performs processing for a normal notification N30 to the addressee (Step S15), and the post processing ends. In Step S15, the server 10 generates a notification ID, and stores the generated notification ID in the notification database DB3 together with notification data indicating the mention designating only an addressee. The server 10 generates notification data indicating a normal notification N30 as the notification type. The server 10 issues a new notification ID, and stores the issued notification ID in the notification database DB3 together with the post ID and the notification data.

When it is determined in Step S14 that a mention designating an addressee and reaction information has been made (“Addressee and Reaction” in Step S14), the server 10 performs processing for a reaction notification N31 to the addressee (Step S16), and the post processing ends. In Step S16, the server 10 generates a notification ID, and stores the generated notification ID in the notification database DB3 together with notification data indicating the mention designating an addressee and reaction information, to thereby request the addressee designated by the mention to perform a reaction indicated by the reaction information designated by the mention. The server 10 generates notification data indicating a reaction notification N31 as the notification type and indicating the specific content of the reaction identified by the reaction definition data. The server 10 issues a new notification ID, and stores the issued notification ID in the notification database DB3 together with the post ID and the notification data.

### [4-2. Notification Processing]

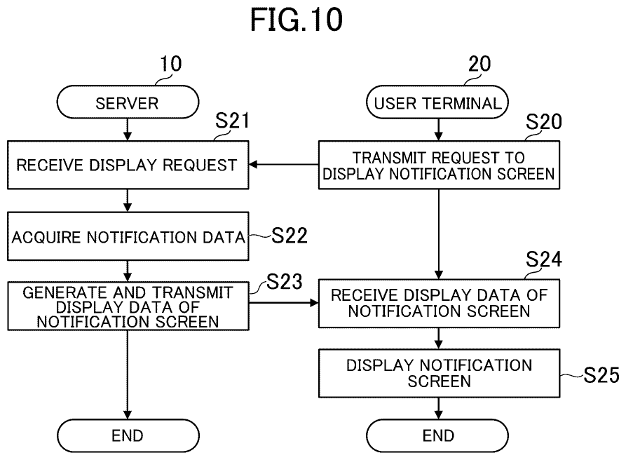

FIG. 10 is a flowchart for illustrating an example of notification processing. For example, when the user selects the icon I10, notification processing is executed. The user terminal 20 transmits to the server 10 a request to display the notification screen SC3 (Step S20). The server 10 receives the request to display the notification screen SC3 (Step S21). The server 10 acquires a piece of notification data relating to the user ID of the user who has made the display request from among the pieces of notification data stored in the notification database DB3 (Step S22). In Step S22, the server 10 acquires the notification data in which the user ID is designated as the addressee.

The server 10 generates display data for the notification screen SC3 based on the notification data acquired in Step S22, and transmits the generated display data to the user terminal 20 (Step S23). In Step S23, when there exists a notification for a mention in which the user who has made the request to display the notification screen SC3 is designated as an addressee and reaction information is also designated, the server 10 generates display data for the notification screen SC3 that includes a reaction notification N31 indicating that the user is requested to perform the reaction. The server 10 requests the user to perform the reaction by transmitting the display data of the notification screen SC3 to the user terminal 20.

The user terminal 20 receives the display data of the notification screen SC3 from the server 10 (Step S24). The user terminal 20 displays the notification screen SC3 on the display unit 25 (Step S25), and the notification processing ends. The user checks the notification screen SC3, and when a reaction notification N31 is displayed on the notification screen SC3, checks the content of the reaction notification N31 and performs the reaction that the user is requested to perform. When the user selects the reaction notification N31, the user terminal 20 executes, between the user terminal 20 and the server 10, processing for displaying the post indicated by the reaction notification N31 on a screen such as the thread screen SC2.

### [5. Summary of at Least One Embodiment]

The work support system 1 according to the at least one embodiment determines, based on posted data, whether or not a mention designating an addressee and reaction information relating to a reaction the addressee is requested to perform has been made. The work support system 1 requests the addressee to perform the reaction when it is determined that the mention has been made. This enables the mentioned user to know that he or she is requested to perform the reaction without being required to read the entire body text of the post, and hence the work support system 1 can increase convenience of the user. For example, when the user receives a large number of notifications, the user may overlook a notification even when some sort of reaction has been requested, and may have difficulty in noticing that he or she has been requested to perform the some sort of reaction. In this regard, when a mention designating an addressee and reaction information is made, the user is more likely to notice that the reaction has been requested.

### [6. Modification Examples]

The present disclosure is not limited to the at least one embodiment described above. The present disclosure can be modified suitably without departing from the spirit of the present disclosure.

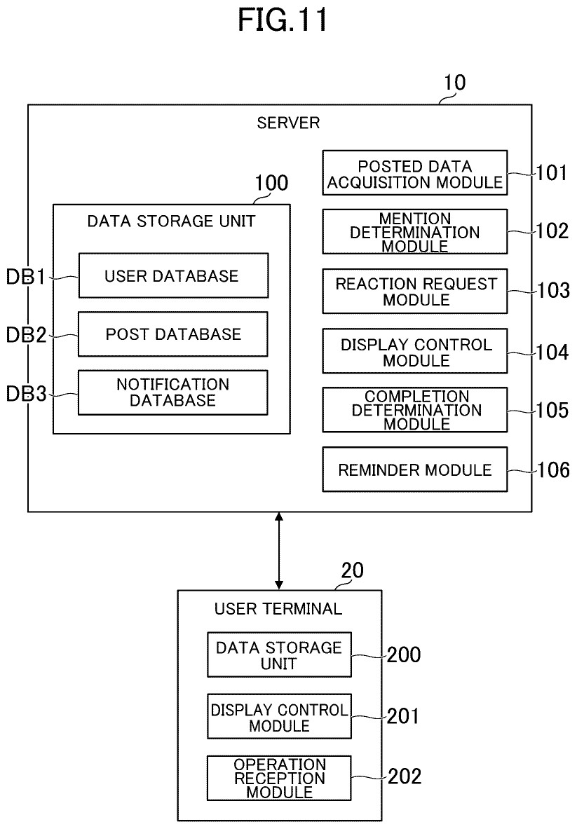

FIG. 11 is a diagram for illustrating an example of functions implemented in the work support system 1 according to modification examples. As illustrated in FIG. 11, in the modification examples described below, a display control module 104, a completion determination module 105, and a reminder module 106 are implemented. Each of the display control module 104, the completion determination module 105, and the reminder module 106 is implemented by the control unit 11.

### [6-1. Modification Example 1]

For example, in the at least one embodiment, a mention designating reaction information for a certain one addressee has been taken as an example. A plurality of addressees may be designated by the mention. In this case, the same reaction information may be designated for each of the plurality of addressees, or mutually different reaction information may be designated for each of the plurality of addressees. In Modification Example 1, a case in which the user U1 requests the user U2 to perform a reply reaction and requests a user U3 to perform a viewing reaction is taken as an example.

In the example of the post of FIG. 4, the user U1 inputs a post that includes not only the character string “@[reply]userU2,” but also the character string “@[check?]userU3.” The character string “@[reply]userU2” means that the user U2 is designated as an addressee and that a reply is designated as reaction information. The character string “@[check?]userU3” means that the user U3 is designated as an addressee and that checking is designated as reaction information. In cases in which another reaction is requested and in cases in which three or more addressees are designated, the reaction information may be designated for the addressee in the same manner.

The mention determination module 102 in Modification Example 1 determines, based on the posted data, whether or not a mention designating a plurality of addressees and reaction information relating to the reaction each of the plurality of addressees is requested to perform has been made. In the above-mentioned example, when the reaction request module 103 detects, based on the posted data, that the post includes the character string “@[reply]userU2” and the character string “@[check?]userU3,” the reaction request module 103 determines that a mention designating the users U2 and U3 as addressees and designating reaction information for each of the users U2 and U3 has been made. For example, the reaction request module 103 determines that a first addressee is requested to perform a first reaction and a second addressee is requested to perform a second reaction.

The reaction request module 103 in Modification Example 1 requests, when the mention designating a plurality of addressees and mutually different pieces of reaction information for the plurality of addressees has been made, each of the plurality of addressees to perform a mutually different reaction. For example, the reaction request module 103 generates, for each addressee designated in the mention, notification data including reaction information designated for each addressee, in which the reaction information indicates a reaction different from that of at least one other addressee. The reaction request module 103 requests each of the plurality of addressees to perform a mutually different reaction by storing the notification data on each of the plurality of addressees in the notification database DB3. For example, the reaction request module 103 requests a first addressee to perform a first reaction and a second addressee to perform a second reaction.

For example, when the reaction request module 103 receives a request to display the notification screen SC3 from the user terminal 20 of a certain user, the reaction request module 103 refers to the notification database DB3 and acquires notification data on the mention designating the user as the addressee. When the notification data indicates a reaction different from that of the other addressees in the mention, the reaction request module 103 generates, based on the notification data, the display data of the notification screen SC3 indicating a reaction different from that of the other addressees. The reaction request module 103 requests the user to perform the reaction different from that of the other addressees by transmitting the display data of the notification screen SC3 to the user terminal 20.

The work support system 1 according to Modification Example 1 requests, when a mention designating a plurality of addressees and mutually different pieces of reaction information for the plurality of addressees has been made, each of the plurality of addressees to perform a mutually different reaction. This enables the user to request, in one post, each of the plurality of addressees to perform mutually different reactions, and hence the work support system 1 can further increase convenience of the user. In the example of Modification Example 1, the necessity for the user U1 to make a post requesting the user U2 to reply to the post separately from a post requesting the user U3 to check the post is eliminated, and hence the work support system 1 can further increase convenience of the user U1. From the standpoint of the users U2 and U3, the work support system 1 can also increase convenience of the users U2 and U3 because the users U2 and U3 can correctly know the reactions that the users U2 and U3 are being requested to perform.

### [6-2. Modification Example 2]

For example, the reaction request module 103 may request, as a reaction, the addressee to perform a work-related task in the work support system 1. A task is not a general reaction such as viewing a post or a notification, but is a reaction specific to a certain user. For example, the task may be a task of approving work performed in an organization, a task of creating a document or an email, a task of scheduling a meeting or an out-of-office event, or any other task. The tasks of the user may be managed by a task management app in the work support system 1. For example, a task may be one of each of the pieces of work included in a workflow.

In Modification Example 2, it is assumed that the task the addressee is requested to perform is designated by the character string “[todo].” The mention determination module 102 determines, based on the posted data, whether or not the post includes the character string “[todo]” indicating that a task is designated. When it is determined that a post includes the character string, the mention determination module 102 determines that the addressee is requested to perform a task as a reaction. When there are a plurality of types of tasks, the mention determination module 102 may determine which task has been designated based on a numerical value, for example, in the character string “[todo].” For example, the reaction request module 103 generates notification data indicating that the addressee designated in the mention is requested to perform a task as a reaction. The reaction request module 103 requests the addressee to perform, as a reaction, the task by storing the notification data in the notification database DB3. When the reaction request module 103 receives a request to display the notification screen SC3 from the user terminal 20 of a certain user, the reaction request module 103 refers to the notification database DB3, and acquires the notification data of the mention in which the user is designated as an addressee. When the notification data indicates a task as a reaction, the reaction request module 103 requests, based on the notification data, the user to perform the task.

The work support system 1 according to Modification Example 2 requests an addressee to perform a work-related task in the work support system 1 as a reaction. This enables the user to know that he or she is requested to perform a task, which is a reaction specific to the work support system 1, and hence the work support system 1 can further increase convenience of the user.

The work support system 1 may use a task management app, which is an app for managing tasks, to manage the tasks a certain user is requested to perform. For example, when a certain user is designated as an addressee and is also requested to perform a reaction, the work support system 1 may register the user ID of the user and the content of the reaction in the task management app in association with each other. The data of each record in the task management app is stored in the data storage unit 100. For example, when the user terminal 20 accesses the task management app, the server 10 displays the content of the records in the task management app on the user terminal 20. In this way, when a mention designating reaction information has been made, a task may be automatically registered in the task management app.

Further, the work support system 1 may manage tasks in the task management app without requesting a reaction as described in Modification Example 2. The work support system 1 may include the posted data acquisition module 101 and the mention determination module 102, and further include a task management module which manages the tasks in the task management app when it is determined that a mention designating a task for an addressee has been made. In this case, it is not required that the work support system 1 include the reaction request module 103. The task management module of the work support system 1 registers the task data relating to the task designated for the addressee in the task management app together with the addressee identification information. The user can operate the user terminal 20 to access the task management app and display the tasks of the user on the user terminal 20. The object of the present disclosure may be another object other than the object described in the “Summary of the Invention.” Thus, in a mode in which the work support system 1 does not include the reaction request module 103, the object of the present disclosure may be another object, such as efficiently managing user tasks, and such an object can be achieved. Such a mode is also within the scope of the present disclosure.

### [6-3. Modification Example 3]

For example, when a plurality of addressees are designated in a mention, all of those addressees may be requested to perform a reaction, or some of those addressees may be requested to perform a reaction. When a group is designated as an addressee, all members of the group may be requested to perform a reaction, or some members of the group may be requested to perform a reaction.

In Modification Example 3, a case in which a user belonging to a certain company mentions a company-wide group, which is a group of all employees, is taken as an example. For example, the company-wide group may be designated by the character string “company-wide.” The user can request all employees belonging to the company-wide group to perform a reply reaction by inputting the character string “@[reply][all]companywide.” The user can request some employees (for example, a given employee) belonging to the company-wide group to perform a reply reaction by inputting the character string “@[reply][some]companywide.” It is assumed that the data indicating the group is stored in the data storage unit 100 in advance.

The mention determination module 102 in Modification Example 3 determines, based on the posted data, whether all addressees are requested to perform the reaction, or whether some addressees are requested to perform the reaction. For example, when the character string “[all]” is included in the post, the mention determination module 102 determines that all addressees are requested to perform the reaction. When the character string “[some]” is included in the post, the mention determination module 102 determines that some addressees are requested to perform the reaction. Those rules may be indicated in the reaction definition data. The mention determination module 102 analyzes the posted data based on the reaction definition data, and determines whether all addressees are requested to perform the reaction or whether some addressees are requested to perform the reaction.

The method by which the mention determination module 102 distinguishes between a reaction all addressees are requested to perform and a reaction some addressees are requested to perform is not limited to the above-mentioned example. For example, the mention determination module 102 may distinguish between a reaction all addressees are requested to perform and a reaction some addressees are requested to perform based on character strings other than the character string “[all]” and the character string “[some].” As another example, in the square brackets immediately after “@,” a character string indicating whether the relevant reaction is a reaction all addressees are requested to perform or a reaction some addressees are requested to perform may be added immediately after the character string “reply,” for example, indicating the reaction. In this case, the mention determination module 102 determines which of the reaction all addressees are requested to perform and the reaction some addressees are requested to perform has been performed based on the added portion.

The reaction request module 103 in Modification Example 3 requests all addressees to perform the reaction when the mention requests that all addressees perform the reaction, and requests some addressees to perform the reaction when the mention requests that some addressees perform the reaction. For example, the reaction request module 103 generates notification data indicating that all addressees designated in the mention are requested to perform the reaction. The reaction request module 103 requests those all addressees to perform the reaction by storing the generated notification data in the notification database DB3. For example, the reaction request module 103 generates notification data indicating that some addressees designated in the mention are requested to perform the reaction. The reaction request module 103 requests those some addressees to perform the reaction by storing the generated notification data in the notification database DB3.

For example, when the reaction request module 103 receives a request to display the notification screen SC3 from the user terminal 20 of a certain user, the reaction request module 103 refers to the notification database DB3 and acquires notification data of the mention designating the user as the addressee. The reaction request module 103 requests the user to perform a reaction based on the notification data. When all addressees are requested to perform the reaction, notification data indicating that a reaction has been requested is acquired regardless of which user has sent the display request, and hence the server 10 can determine that the reaction all users have been requested to perform has been performed when the user who has sent the display request performs the reaction. When some users are requested to perform the reaction, when a display request is sent by any one of those some users, notification data indicating that the reaction has been requested is acquired, and hence the server 10 can determine that the reaction some users have been requested to perform has been performed when the user who has sent the display request performs the reaction.

A status indicating whether or not the reaction designated for an addressee has been completed may be managed. In this case, the status of each reaction may be stored in the notification database DB3 or stored in another database. The status of a reaction requested to be performed by all addressees is indicated as being “complete” when all addressees have completed the reaction. The status of a reaction requested to be performed by some addressees is indicated as being “complete” when those some addressees have completed the reaction. The server 10 may determine whether or not the reaction is complete based on data received from the user terminals 20, and update the status.

In the work support system 1 according to Modification Example 3, when a mention requests that all addressees perform a reaction, all addressees are requested to perform the reaction, and when a mention requests that some addressees perform a reaction, those some addressees are requested to perform the reaction. As a result, the user can flexibly differentiate between mentions requesting the reaction from all addressees and mentions requesting the reaction from some addressees, and hence the work support system 1 can further increase convenience of the user.

### [6-4. Modification Example 4]

For example, when a certain user himself or herself is designated as an addressee and is also requested to perform some sort of reaction, a display indicating that the user is requested to perform the reaction may be displayed on the thread screen SC2 of the user. The reaction request module 103 in Modification Example 4 requests the addressee to perform the reaction by displaying a thread screen SC2 showing the post and the reaction the user is requested to perform on the user terminal 20 of the user corresponding to the addressee.

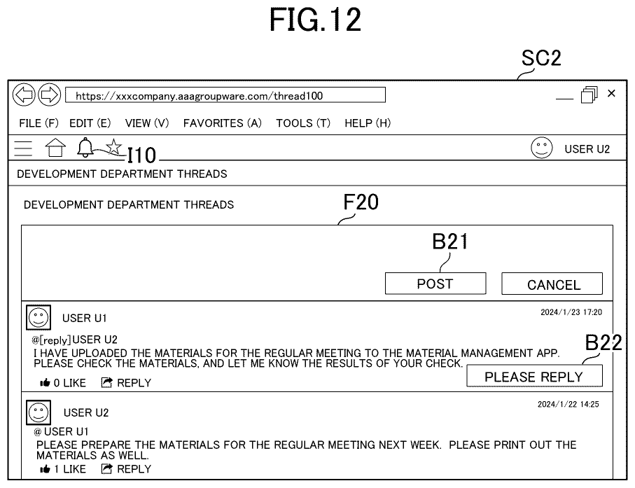

FIG. 12 is a view for illustrating an example of the thread screen SC2 in Modification Example 4. FIG. 12 shows an example of the thread screen SC2 that is displayed when the user U2 selects, from the notification screen SC3 in the lower half of FIG. 4, a reaction notification N31 in which a reply reaction is requested. For example, the reaction request module 103 displays, on the thread screen SC2, a button B22 indicating the content of the reaction the user U2 is requested to perform together with the post indicated by the reaction notification N31 selected by the user U2. When the user selects the button B22, the user terminal 20 notifies the server 10 that the reaction has been completed. When the server 10 receives the notification that the reaction has been completed, the server 10 records data indicating that the reaction has been completed (for example, the status described in Modification Example 3) in the data storage unit 100.

For example, the reaction request module 103 refers to the post database and acquires the posted data of the post to be displayed. In the example of FIG. 12, the post to be displayed is the post indicated by the reaction notification N31 selected by the user. The post to be displayed may be another post. For example, another post having a posting date and time close to those of the post indicated by the reaction notification N31 selected by the user may be the post to be displayed. The reaction request module 103 refers to the notification database DB3 and identifies the reaction requested in the post to be displayed. The reaction request module 103 generates display data of the thread screen SC2 including the post indicated by the acquired posted data and the button B22 corresponding to the identified reaction. The reaction request module 103 displays the thread screen SC2 of FIG. 12 on the user terminal 20 by transmitting the display data of the thread screen SC2 to the user terminal 20.

The thread screen SC2 is an example of a post screen. Thus, the term “thread screen SC2” can be read as “post screen.” The post screen is a screen on which at least a part of the post is displayed. The post screen may be another screen other than the thread screen SC2. For example, the notifications on the notification screen SC3 indicate at least a part of the post, and hence the notification screen SC3 may correspond to the post screen. As another example, a screen showing comments posted to an app of the work support system 1, a screen showing comments posted to a shared email, a screen showing comments posted to a schedule, or another screen may correspond to the post screen. The reaction request module 103 can display, on any post screen, posts in which a certain addressee has been designated in a mention, and the reaction the addressee is requested to perform.

The work support system 1 according to Modification Example 4 requests an addressee to perform a reaction by displaying, on the user terminal of the user corresponding to the addressee, a thread screen SC2 showing a post and the reaction the user is requested to perform. As a result, the user can grasp in more detail and more clearly what kind of reaction has been requested in what kind of post, and hence the work support system 1 can further increase convenience of the user.

### [6-5. Modification Example 5]

For example, in Modification Example 4, the thread screen SC2 of the mentioned user U2 has been taken as an example, but the content of the reaction the user U2 is requested to perform may also be shown on the thread screen SC2 of the user U1 who has made the mention. That is, the user U1 may be able to see, on his or her own thread screen SC2, the reaction the user U1 has requested the user U2 to perform. The work support system 1 according to Modification Example 5 includes the display control module 104. The display control module 104 displays, on the user terminal 20 of the user U1 who has made a post, the thread screen SC2 showing the post and the reaction requested by the user U1.

For example, after the user U1 has made the post illustrated in the upper half of FIG. 4, a button B22 similar to that in FIG. 12 is displayed on the thread screen SC2 displayed on the user terminal 20 of the user U1. For example, the display control module 104 may display, on the thread screen SC2, a button B23 showing the content of the reaction the user U1 has requested the user U2 to perform together with the post made by the user U1. The content of the reaction may be shown by using another image other than the button B23. The content of the reaction may be shown by using other information such as text instead of an image. It is assumed that the data required for displaying the content of the reaction is stored in the data storage unit 100. It is also assumed that data indicating which information is to be displayed in relation to which designated reaction information is also stored in the data storage unit 100. The display control module 104 may display the thread screen SC2 on the user terminal 20 based on those pieces of data. Similarly to Modification Example 4, those pieces of data may be used.

For example, the display control module 104 refers to the post database and acquires the posted data of the post to be displayed. The post to be displayed is the post made by the user. Similarly to Modification Example 4, the post to be displayed may be another post. The display control module 104 refers to the notification database DB3 and identifies the reaction requested in the post to be displayed. The display control module 104 generates display data of the thread screen SC2 including the post indicated by the acquired posted data and the button B23 corresponding to the identified reaction. The display control module 104 displays the thread screen SC2 on the user terminal 20 by transmitting the display data of the thread screen SC2 to the user terminal 20.

Similarly to Modification Example 4, the thread screen SC2 is an example of a post screen. In addition, in Modification Example 5 as well, the term “thread screen SC2” can be read as “post screen.” Similarly to Modification Example 4, the post screen in Modification Example 5 may be another screen other than the thread screen SC2. The display control module 104 can display, on any post screen, the post made by the user who has displayed the post screen and the reaction the user has requested the addressee to perform.

The work support system 1 according to Modification Example 5 displays, on the user terminal 20 of the user who has made a post, a thread screen SC2 showing the post and the reaction requested by the user. As a result, the user can grasp in more detail and more clearly what kind of reaction has been requested to be performed by the addressee in what kind of post, and hence the work support system 1 can further increase convenience of the user.

### [6-6. Modification Example 6]

For example, in the mention of the work support system 1, not only the addressee and the reaction but also a complete-by time of the reaction may be designated. In Modification Example 6, a case in which the user U1 designates Feb. 29, 2024, as the complete-by time of a reply reaction for the user U2 is taken as an example. For example, on the thread screen SC2 in the upper half of FIG. 4, the user U1 requests the user U2 to perform a reply reaction by Feb. 29, 2024, by inputting the character string “@[reply][2024/2/29/]UserU2.”

The mention determination module 102 in Modification Example 6 determines whether or not a mention additionally designating a complete-by time of the reaction has been made. For example, the mention determination module 102 determines whether or not a specific character string indicating a complete-by time of the reaction is included based on the posted data. In the above-mentioned example, the mention determination module 102 determines whether or not a mention additionally designating a complete-by time has been made by determining whether or not a character string indicating a complete-by time is included in the second square brackets after the specific symbol “@.”

The character string indicating the complete-by time may be in any format determined in advance. For example, the character string indicating the complete-by time may be the character string “YYYY/MM/DD” indicating the year, month, and day, “MM/DD” indicating only the month and day without the year, the character string “urgent” indicating urgent, the character string “ASAP” indicating as soon as possible, or another character string. It is assumed that complete-by time format data indicating the format of the character string indicating the complete-by time is stored in the data storage unit 100. When the post indicated by the posted data does not include a character string in the format indicated by the complete-by time format data, the mention determination module 102 determines that a complete-by time is not designated, and when the post includes a character string in the relevant format, determines that a complete-by time is designated.

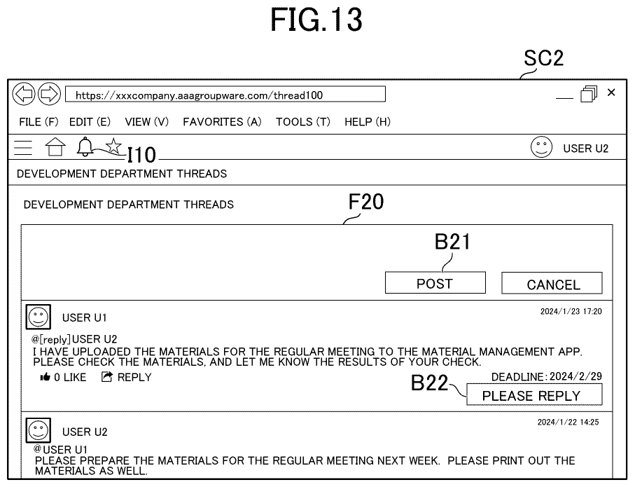

FIG. 13 is a view for illustrating an example of the thread screen SC2 in Modification Example 6. In FIG. 13, a case in which a complete-by time is notified on a thread screen SC2 similar to that in Modification Example 4 is taken as an example. The reaction request module 103 in Modification Example 6 requests the addressee designated in the mention to complete the reaction by the complete-by time. For example, the reaction request module 103 displays, on the thread screen SC2, the post in which the user U2 is mentioned, the button B22 indicating the content of the reaction the user U2 is requested to perform, and the character string “Feb. 29, 2024” indicating the complete-by time.

The work support system 1 according to Modification Example 6 determines whether or not a mention additionally designating a complete-by time of a reaction has been made. The work support system 1 requests the addressee to complete the reaction by the complete-by time. The mentioned user can know not only the reaction that the mentioned user is requested to perform, but also the complete-by time of the reaction, and hence the work support system 1 can increase convenience of the user.

### [6-7. Modification Example 7]

For example, even when a reaction has been requested, the user may forget to perform the reaction. Thus, a reminder may be issued to a user who has not performed the reaction. In Modification Example 7, similarly to Modification Example 6, a case in which a complete-by time is designated for the reaction is taken as an example. For example, the user U1 designates Feb. 29, 2024, as the complete-by time, and requests the user U2 to perform a reply reaction. In Modification Example 7, when the user U2 has not replied to the post by the user U1 by Feb. 29, 2024, the user U2 receives a reminder.

The work support system 1 according to Modification Example 7 includes the completion determination module 105 and the reminder module 106. The completion determination module 105 determines whether or not the reaction has been completed. For example, the completion determination module 105 determines whether or not the reaction has been completed based on data indicating that the reaction described in Modification Example 4 has been completed. When Modification Example 6 and Modification Example 7 are combined, the completion determination module 105 may acquire the current date and time based on a publicly-known method such as a real-time clock or GPS, and determine whether or not the complete-by time has passed.

The reminder module 106 issues a reminder to the addressee when it is determined that the reaction has not been completed. For example, the reminder module 106 uses a notification function of the work support system 1 to issue the reminder to the addressee. The reminder may be issued by using any method. For example, the reminder module 106 may issue the reminder to the addressee by using an email, an SMS, a push notification, a banner notification, a badge notification, a messaging app, an SNS, or another method. A plurality of those reminder methods may be combined.

In Modification Example 7, it is not required that a complete-by time for the reaction like Modification Example 6 be designated. In this case, the completion determination module 105 may determine whether or not or not the reaction has been completed when a predetermined period of time has passed since the post was made. The predetermined period of time may have any length. For example, the predetermined period of time may be about three days, one week, or one month. It is assumed that data indicating the length of the predetermined period of time is stored in the data storage unit 100 in advance. The reminder module 106 may issue a reminder to the addressee when the reaction has not been performed even after the predetermined period of time has passed since the post was made. As another example, the reminder module 106 may issue a reminder to the addressee when the user who has made the post for which the reaction has not been performed performs a reminder operation.

The work support system 1 according to Modification Example 7 determines whether or not the reaction has been completed. The work support system 1 issues a reminder to the addressee when it is determined that the reaction has not been completed. The user who has been requested to perform the reaction can notice, based on the reminder, the reaction he or she has not completed, and hence the work support system 1 can increase convenience of the user who has been requested to perform the reaction. Even from the standpoint of the user who has requested the reaction, the reminder can prevent the reaction from being forgotten to be performed, and hence the work support system 1 can also increase the convenience of the user who has requested the reaction.

### [6-8. Modification Example 8]

For example, as described in the at least one embodiment, in the mention of the work support system 1, at least one of a plurality of pieces of reaction information is designated. In the example of FIG. 4, regardless of which of the plurality of pieces of reaction information is designated, the reaction notifications N31 are collectively displayed in the reaction notification N31 field of the notification screen SC3. In Modification Example 8, a case in which, for each reaction, the reaction notifications N31 are displayed so as to be distinguishable is taken as an example.

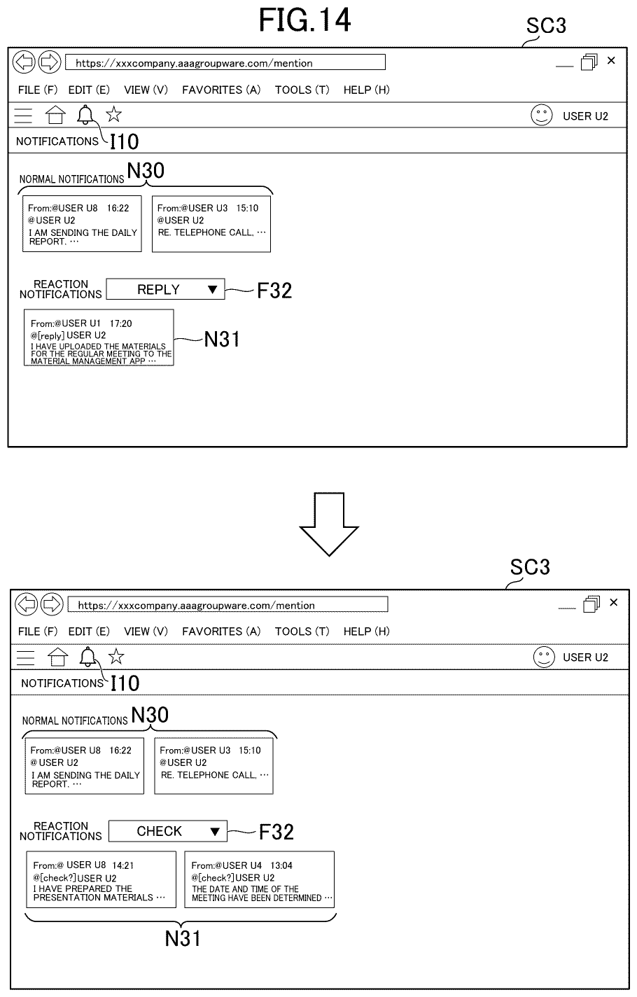

FIG. 14 is a view for illustrating an example of the notification screens SC3 in Modification Example 8. The reaction request module 103 in Modification Example 8 requests the addressee to perform a reaction by displaying, on the user terminal 20 of the user corresponding to the addressee, for each reaction the user is requested to perform, a notification screen SC3 showing a notification relating to the post in which the relevant reaction is requested. For example, the reaction request module 103 filters the plurality of reaction notifications N31 based on the content of the reactions designated by the user, and displays the filtered reaction notifications N31. The reaction request module 103 may identify the content of the reactions based on the notification data stored in the notification database DB3.

For example, as in the upper half of FIG. 14, when the user inputs a reply reaction into the input form F32, the reaction request module 103 filters, of the reaction notifications N31 issued for the user, the reaction notifications N31 in which a reply designated by the user is requested as the reaction, and displays the filtered reaction notifications N31. As in the lower half of FIG. 14, when the user inputs a check reaction into the input form F32, the reaction request module 103 filters, of the reaction notifications N31 issued for the user, the reaction notifications N31 in which a check designated by the user is requested as the reaction, and displays the filtered reaction notifications N31.

The reaction request module 103 may display, on the notification screen SC3, for each reaction, the reaction notifications N31 of the posts in which the reaction is requested without particularly filtering. For example, the reaction request module 103 displays, on the notification screen SC3 of the user U1, each of the plurality of reactions requested by the user U1 in association with the reaction notification N31 of the relevant reaction. The reaction request module 103 may associate the reactions with the relevant reaction notification N31 by arranging the reaction notification N31 of the relevant reaction below the content of the reaction.

The method by which the reaction request module 103 associates the reactions with the reaction notifications N31 is not limited to the example of FIG. 14. For example, the reaction request module 103 may display the reactions in association with the reaction notifications N31 by arranging the reaction notification N31 above, to the left, or to the right of the content of the reaction. When the user U1 selects a reaction, the reaction request module 103 may display the reaction in association with the reaction notification N31 by filtering the reaction notifications N31 of the posts in which the relevant reaction has been requested and displaying the filtered reaction notifications N31 on the notification screen SC3.

The work support system 1 according to Modification Example 8 requests the addressee to perform a reaction by displaying, on the user terminal 20 of the user corresponding to the addressee, for each reaction the user is requested to perform, a notification screen SC3 showing a notification relating to the post in which the relevant reaction is requested. This enables the user to more easily grasp the reaction the user is requested to perform from the notification screen SC3, and hence the work support system 1 can further increase convenience of the user.

### [6-9. Modification Example 9]

For example, the method of designating the reaction information in a mention is not limited to the example of the at least one embodiment. In the at least one embodiment, a case in which reaction information is designated by a character string in square brackets after a specific symbol “@” indicating a mention has been described. Such a designation method is a method in which the reaction information is designated based on a notation of the post. The mention determination module 102 in Modification Example 9, in which the reaction information may be designated by using another notation, determines whether or not a mention has been made based on a predetermined notation relating to the designation of the reaction information.

As used herein, “notation” refers to an input method for indicating that reaction information has been designated. The mention determination module 102 may determine that reaction information is designated in a mention based on another notation other than the notation described in the at least one embodiment. For example, the mention determination module 102 may identify the reaction information designated in a mention based on a notation that uses a certain one symbol. In Modification Example 9, a case in which the symbol “?” indicates a reply reaction and the symbol “!” indicates a check reaction is taken as an example. It is assumed that notation data indicating which symbol means which reaction is stored in the data storage unit 100.

For example, the mention determination module 102 determines, based on the posted data and the notation data, whether or not a post has been made with the notation indicated by the notation data. In the above-mentioned example, the mention determination module 102 determines that reply reaction information is designated in the post indicated by the posted data when the symbol “?” indicating a reply reaction is arranged after the specific symbol “@” indicating a mention. The mention determination module 102 determines that check reaction information is designated in the post indicated by the posted data when the symbol “!” indicating a check reaction is arranged after the specific symbol “@” indicating a mention.

The work support system 1 according to Modification Example 9 determines whether or not a mention has been made based on a predetermined notation relating to designation of reaction information. The user can request an addressee perform a reaction by making a post which is in accordance with the predetermined notation, and hence the work support system 1 can simplify the method of designating reaction information.

### [6-10. Modification Example 10]

For example, the method of designating reaction information in a mention is not limited to the method described in the at least one embodiment or to a notation like in Modification Example 9. In Modification Example 10, when a user is to make a post, options of a plurality of pieces of reaction information are displayed on the thread screen SC2. The user designates the reaction information by selecting an option. The work support system 1 according to Modification Example 10 includes the display control module 104. The display control module 104 displays, on the user terminal 20 of the user who is to make the post, a thread screen SC2 which receives a selection of at least one of a plurality of pieces of reaction information. Similarly to Modification Example 4, the thread screen SC2 is an example of a post screen.

For example, on the thread screen SC2 in Modification Example 10, when the user inputs the specific symbol “@” indicating a mention, options indicating a plurality of pieces of reaction information are displayed. When the user selects any of those options, the reaction information designated by the user is displayed on the thread screen SC2. The display control module 104 generates display data of the thread screen SC2 including a script for displaying the options. The display control module 104 displays, on the user terminal 20, the thread screen SC2 which receives a selection of at least one of the plurality of pieces of reaction information by transmitting the display data of the thread screen SC2 to the user terminal 20.

The mention determination module 102 in Modification Example 10 determines whether or not a mention designating the reaction information selected by the user on the thread screen SC2 has been made. For example, the reaction information selected by the user is indicated in the posted data that the posted data acquisition module 101 receives from the user terminal 20. The mention determination module 102 may determine whether or not a mention designating reaction information has been made by determining whether or not the posted data indicates reaction information.

The work support system 1 according to Modification Example 10 displays, on the user terminal 20 of the user who is to make the post, a thread screen SC2 which receives a selection of at least one of a plurality of pieces of reaction information. The work support system 1 determines whether or not a mention designating the reaction information selected by the user on the thread screen SC2 has been made. The user can designate the reaction information by making a selection on the thread screen SC2 without particularly remembering a notation, and hence the work support system 1 can further increase convenience of the user.

### [6-11. Other Modification Examples]

For example, two or more of Modification Examples 1 to 10 may be combined.

For example, the functions described as being implemented by the server 10 may be implemented by the user terminal 20. In this case, it suffices that the functions are implemented by a browser script or an application installed on the user terminal 20. For example, the respective functions may be distributed to a plurality of computers, or may be implemented by a single computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A work support system, comprising at least one processor configured to:
acquire posted data relating to a post in the work support system;
determine, based on the posted data, whether a mention designating an addressee and reaction information relating to a reaction the addressee is requested to perform has been made; and
request the addressee to perform the reaction when it is determined that the mention has been made.

2. The work support system according to claim 1, wherein the at least one processor is configured to request, when the mention designating a plurality of addressees and mutually different pieces of reaction information for the plurality of addressees has been made, each of the plurality of addressees to perform a mutually different reaction.

3. The work support system according to claim 1, wherein the at least one processor is configured to request the addressee to perform a work-related task in the work support system as the reaction.

4. The work support system according to claim 1, wherein the at least one processor is configured to request all addressees to perform the reaction when the mention requests that the all addressees perform the reaction, and request some addressees to perform the reaction when the mention requests that the some addressees perform the reaction.

5. The work support system according to claim 1, wherein the at least one processor is configured to request the addressee to perform the reaction by displaying, on a user terminal of a user corresponding to the addressee, a post screen showing the post and the reaction the user is requested to perform.

6. The work support system according to claim 1, wherein the at least one processor is configured to display, on a user terminal of a user who has made the post, a post screen showing the post and the reaction requested by the user.

7. The work support system according to claim 1, wherein the at least one processor is configured to:
determine whether the mention which additionally designates a complete-by time of the reaction has been made; and
request the addressee to complete the reaction by the complete-by time.

8. The work support system according to claim 1, wherein the at least one processor is configured to:
determine whether the reaction has been completed; and
issue a reminder to the addressee when it is determined that the reaction has not been completed.

9. The work support system according to claim 1,
wherein at least one of a plurality of pieces of the reaction information is designated in the mention, and
wherein the at least one processor is configured to request the addressee to perform the reaction by displaying, on a user terminal of a user corresponding to the addressee, for each reaction the user is requested to perform, a notification screen showing a notification relating to the post in which the each reaction is requested.

10. The work support system according to claim 1, wherein the at least one processor is configured to determine whether the mention has been made based on a predetermined notation relating to designation of the reaction information.

11. The work support system according to claim 1, wherein the at least one processor is configured to:
display, on a user terminal of a user who is to make the post, a post screen for receiving a selection of at least one of a plurality of pieces of the reaction information; and
determine whether the mention which designates the at least one of the plurality of pieces of the reaction information selected by the user on the post screen has been made.

12. A work support method, comprising:
acquiring posted data relating to a post in a work support system;
determining, based on the posted data, whether a mention designating an addressee and reaction information relating to a reaction the addressee is requested to perform has been made; and
requesting the addressee to perform the reaction when it is determined that the mention has been made.

13. A non-transitory information storage medium having stored thereon a program for causing a computer to:
acquire posted data relating to a post in a work support system;
determine, based on the posted data, whether a mention designating an addressee and reaction information relating to a reaction the addressee is requested to perform has been made; and
request the addressee to perform the reaction when it is determined that the mention has been made.
